(19) United States
(12) Patent Application Publication
(10) Pub. No.: US 2022/0017331 A1
(43) Pub. Date: Jan. 20, 2022

(54) ELEVATOR CONTROL APPARATUS

(71) Applicant: Hitachi, Ltd., Tokyo (JP)

(72) Inventors: Yuki SAITO, Tokyo (JP); Youhei MATSUMOTO, Tokyo (JP); Takamichi HOSHINO, Tokyo (JP)

(21) Appl. No.: 17/295,145

(22) PCT Filed: Dec. 14, 2018
(86) PCT No.: PCT/JP2018/046145

§ 371 Date: May 19, 2021

(51) Int. Cl. B66B 5/06; B66B 1/34

(52) U.S. Cl. CPC B66B 5/06; B66B 1/3446; B66B 1/3492

(57) ABSTRACT

An elevator control apparatus improves car position detection accuracy without increasing the number of sensors. A position detection sensor installed on a caroutputs a detection signal when an object installed in a hoistway is detected. A controller corrects a position of the car calculated on the basis of a pulse signal that an encoder which rotates in accordance with ascending and descending of the car outputs, in accordance with a position of the object to be detected. A storage device stores data on the position of the car calculated prior to a time point when the detection signal is received. A correction amount of the position of the car is calculated on the basis of a communication delay time and the data which is stored in the storage device, and the position of the car is corrected in accordance with the correction amount.

### TECHNICAL FIELD

The present invention relates to a control apparatus for an elevator.

### BACKGROUND ART

In many elevators, an elevator control apparatus calculates a position of a car by using a pulse signal which is generated from an encoder which is installed on a traction machine and a governor and thereby performs speed control. However, a calculated value of the above-described car position deviates from an actual car position due to slipping between a sheave of the traction machine and a main rope, slipping between a governor pulley and a governor rope, or elongation of the main rope.

In order to correct this deviation and then to realize highly accurate floor-landing control, a detection sensor which is installed on a car corrects a position calculated value to a value of each floor position which is measured in advance at a timing that it detects an object to be detected which is installed at each floor position in a hoistway.

In this case, when a delay occurs between when the detection sensor detects the object to be detected and when a detection signal is input into a controller, correction accuracy is lowered. In particular, when a radio communication is performed between the car and the elevator control apparatus, a signal delay is great and it becomes difficult to properly correct it.

In contrast, the prior art which is described in Patent Literature 1 is known. In the present prior art, in an elevator that a car and an elevator control panel wirelessly communicate with each other, an approach of the object to be detected which is attached to the car is detected by a position detection device which is disposed on the building side and communicates with the elevator control panel in a wired manner. The position of the car which is arithmetically operated from an output signal from the encoder is corrected depending on an output signal from this position detection device.

### CITATION LIST

### Patent Literature

Patent Literature 1: Japanese Patent Application Laid-Open No. 2003-201073

### SUMMARY OF INVENTION

### Technical Problem

In the above-described prior art, the detection sensor should be installed at each floor position and there is such a problem that the number of sensors which are used in the elevator apparatus is increased.

Accordingly, the present invention provides an elevator control apparatus which can improve the car position detection accuracy without increasing the number of the sensors.

### Solution to Problem

In order to solve the abovementioned problem, the elevator control apparatus according to the present invention which, upon receiving a detection signal that a position detection sensor which is installed on a car outputs when the position detection sensor detects an object to be detected which is installed in a hoistway, corrects a position of the car calculated on the basis of a pulse signal that an encoder which rotates in accordance with ascending and descending of the car outputs, in accordance with a position of the object to be detected, has a storage device which stores data on the position of the car calculated prior to a time point when the detection signal from the position detection sensor is received, and a correction amount of the position of the car is calculated on the basis of a communication delay time and the data which is stored in the storage device, and the position of the car is corrected in accordance with the correction amount.

### Advantageous Effects of Invention

According to the present invention, the car position detection accuracy can be improved without increasing the number of the sensors.

Problems, features and effects other than the above-described ones will become apparent from the following description of an embodiment.

### BRIEF DESCRIPTION OF DRAWINGS

FIG. 1 is an overall configuration diagram of an elevator according to one embodiment of the present invention.

FIG. 2 is a configuration diagram of a partial memory of a safety controller according to one embodiment of the present invention.

FIG. 3 is a flowchart for correcting current position data according to one embodiment of the present invention.

### DESCRIPTION OF EMBODIMENTS

In the following, one embodiment of the present invention will be described by using the drawings.

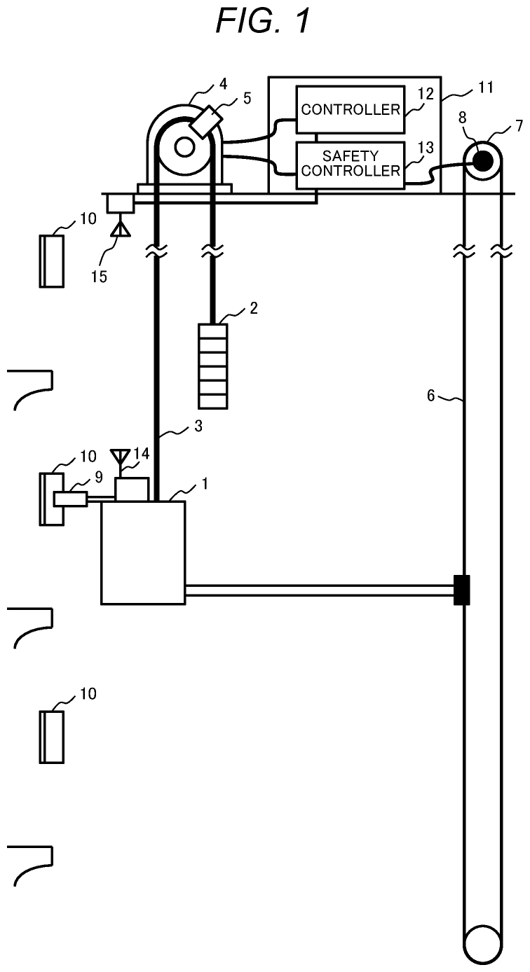

FIG. 1 illustrates an overall configuration of an elevator which is one embodiment of the present invention.

As illustrated in FIG. 1, a car 1 and a counter weight 2 are connected to one end and the other end of a main rope 3 respectively. That is, the car 1 and the counter weight 2 are mutually coupled via the main rope 3. The main rope 3 is wound on a sheave that a traction machine 4 has. Thereby, the car 1 and the counter weight 2 are hung down in a hoistway. Accordingly, the elevator of the present embodiment is a so-called traction-type elevator.

When an electric motor that the traction machine 4 has rotates the sheave, the main rope 3 is driven. Thereby, the car 1 and the counter weight 2 ascend and descend in the hoistway in mutually opposite directions. In addition, when rotation of the electric motor is stopped by a brake 5 that the traction machine 4 has, the car 1 and the counter weight come to a stop.

A governor 7 which has an encoder 8 is installed on the top of the hoistway. An endless governor rope 6 is wound on a governor pulley that the governor 7 has and a tension pulley which is installed on the bottom of the hoistway. The governor rope 6 is engaged with the car 1. Thereby, the governor rope 6 is driven in accordance with movement of the car 1, and the governor pulley of the governor 7 rotates. The encoder 8 rotates together with the governor pulley and outputs a pulse signal in accordance with rotation.

Incidentally, when a speed of the car 1 is abnormal, the governor 7 operates and restrains movement of the governor rope 6. An engagement part between the car 1 and the governor rope 6 stops together with the governor rope 6 and, on the other hand, the car 1 keeps moving. In accordance therewith, a safety device (not illustrated) which is installed on the car 1 operates and stops the car 1.

The car 1 has a position detection sensor 9 on an upper part on the outside a cab. The position detection sensor 9 detects an object 10 to be detected which is installed at each floor position. An installation position of the object 10 to be detected is set such that when the car 1 is landed and comes to a stop at a predetermined position with no deviation, the position detection sensor 9 is positioned at a predetermined position of the object 10 to be detected. Incidentally, in the present embodiment, the installation position of the object 10 to be detected is set such that the position detection sensor 9 is positioned at a vertical direction central part of the object 10 to be detected.

An elevator control panel 11 has a controller 12 and a safety controller 13.

The controller 12 outputs an operation command to a motor and the brake 5 that the traction machine 4 has and controls ascending and descending operations of the car 1.

The safety controller 13 is connected with the encoder 8 in a wired manner. In addition, the safety controller 13 is wirelessly connected with the position detection sensor 9 via a car-side terminal device 14 which is installed on the car 1 and a control-panel-side terminal device 15 which is installed on the top of the hoistway.

The safety controller 13 calculates a position and a speed of the car 1 on the basis of a pulse signal from the encoder 8.

In addition, when the safety controller 13 receives a detection signal that the position detection sensor 9 outputs when detecting the object 10 to be detected, the safety controller 13 corrects the position and the speed of the car 1 calculated on the basis of the pulse signal from the encoder 8, on the basis of the position of the floor on which the object to be detected is installed or the position of the object to be detected which is detected. When deviation from a normal operation range of the car 1 and overspeed thereof are decided, it shuts down power supply to the electric motor and the brake 5 of the traction machine 4 and brings the car 1 into a braked state.

In addition, the safety controller 13 transmits a position calculated value of the car 1 to the controller 12. The controller 12 executes speed control and floor-landing control by using the received position calculated value.

Incidentally, when the safety controller 13 detects something abnormal in an elevator system, it may transmit a stop command to the controller 12. In this case, when the controller 12 receives the stop command, it stops normal ascending and descending operations of the car 1. That is, the controller 12 switches an operation mode, an emergency control operation. In the emergency control operation, for example, the car 1 moves to the nearest floor and comes to a stop.

Time (in the present embodiment, 1 ms is set as a minimum unit) synchronization is set up between the car-side terminal device 14 and the control-panel-side terminal device 15. The car-side terminal device 14 adds time information to a state in a detection of the position detection sensor 9 and transmits it to the control-panel-side terminal device 15. The control-panel-side terminal device 15 measures a delay time (in milliseconds) of radio communication from the time information which is included in the data that the control-panel-side terminal device 15 receives and a time of the control-panel-side terminal device itself when the control-panel-side terminal device 15 receives the data. The control-panel-side terminal device 15 transmits the received state in the detection of the position detection sensor 9 and the measured communication delay time to the safety controller 13 in a wired manner.

Additionally, in the present embodiment, signal delays from the encoder 8 to the safety controller 13 and from the control-panel-side terminal device 15 to the safety controller 13 are sufficiently smaller than a delay time between the car-side terminal device 14 and the control-panel-side terminal device 15.

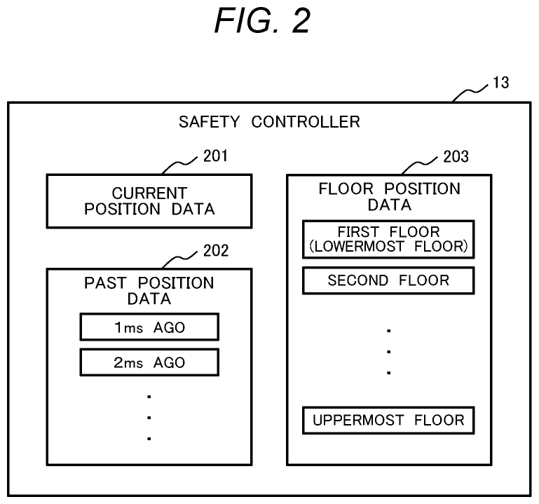

FIG. 2 illustrates a data configuration of a storage device that the safety controller 13 of the present embodiment has.

The storage device of the safety controller 13 stores the position calculated value of the car 1 that the safety controller 13 calculates, as current position data 201. In addition, the storage device stores the position calculated values of the car 1 per predetermined time interval (1 ms in the present embodiment) from a time point at which a detection signal from the position detection sensor 9 is received until just before a predetermined time, as past position data 202 in time series. In the present embodiment, the past position data 202 is position calculated values calculated 1 ms ago, 2 ms ago, . . . , n ms ago (n is a natural number) from the current time point.

Further, the safety controller 13 stores floor position data 203. The floor position data 203 is a value that, at the time of start-up of the elevator and the time of adjustment thereof, a half of the vertical length of the object 10 to be detected is added to the current position data 201 when the car 1 is moved from the lowermost floor to the uppermost floor at a low speed and the position detection sensor 9 detects the lower end part of the object 10 to be detected at each floor. Accordingly, the floor position data 203 coincides with the current position data 201 when the car 1 stops at each floor with no landing deviation and indicates a position of the object 10 to be detected in the hoistway at the position of the half of the vertical length of the object 10 to be detected.

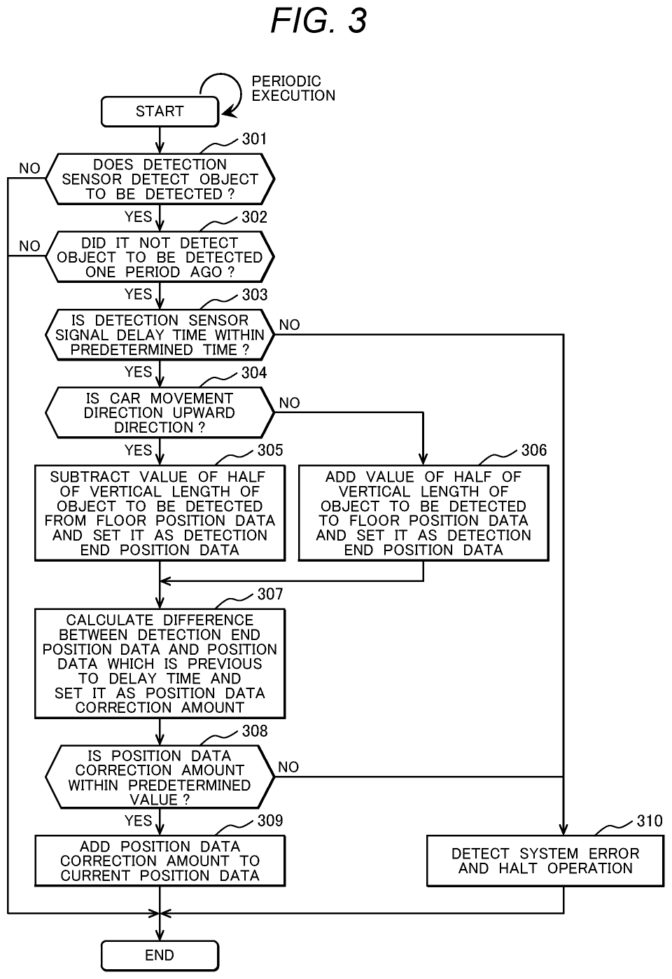

FIG. 3 is a flowchart illustrating processing of correcting the current position data 201 by the safety controller 13 in the present embodiment. The processing of the present flowchart is periodically executed. That period is set sufficiently short so as to obtain desirable control accuracy. Incidentally, a processing device such as a microcomputer etc. executes a predetermined program and thereby the safety controller 13 of the present embodiment performs the processing of the flowchart.

As illustrated in FIG. 3, in step 301, the safety controller 13 decides whether the position detection sensor 9 detects the object 10 to be detected. Since the safety controller 13 executes a decision process on the basis of a detection state signal of the position detection sensor 9 received from the control-panel-side terminal device 15, when the detection state signal is not transferred to the safety controller 13, the safety controller 13 decides no detection, even if the position detection sensor 9 detects the object 10 to be detected. When the safety controller 13 decides detecting the object 10 to be detected (YES in step 301), the safety controller 13 executes step 302 next, and when the safety controller 13 decides no detection (NO in step 301), the safety controller 13 ends a series of processes.

In step 302, the safety controller 13 decides whether the position detection sensor 9 does not detect the object 10 to be detected one period ago. When the safety controller 13 decides not detecting the object 10 to be detected (YES in step 303), that is, when the safety controller 13 decides not detecting the object 10 to be detected in the process in step 301 one control period ago, the safety controller 13 executes step 303 next. In this case, the position detection sensor 9 shifts from a non-detection state to a detection state. When the safety controller 13 decides detecting the object 10 to be detected also one period ago (NO in step 302), the safety controller 13 ends the series of processes.

In step 303, the safety controller 13 decides whether a delay time, which the control-panel-side terminal device 15 measures, of a radio-communication signal is within a predetermined time. When the delay time is within the predetermined time (YES in step 303), the safety controller 13 executes step 304 next, and when the delay time is not within the predetermined time (NO in step 303), that is, when the delay time is larger than the predetermined time, the safety controller 13 executes step 310 next.

In step 304, the safety controller 13 decides whether the movement direction of the car 1 is the upward direction on the basis of the pulse signal from the encoder 8. When the movement direction is the upward direction (YES in step 304), the safety controller 13 executes step 305 next, and when the movement direction is not the upward direction (NO in step 304), that is, when the movement direction is the downward direction, the safety controller 13 executes step 306 next.

In step 305, the safety controller 13 calculates a detection end position by subtracting a value of the half (½) of the vertical direction length of the object 10 to be detected which is set in advance by the safety controller 13 from the data which is the closest to the current position data 201 of the floor position data 203 on the respective floors. Here, since the movement direction of the car is the upward direction, detection end position data indicates the position of the car 1 when the position detection sensor 9 detects the lower end of the object 10 to be detected. After execution of step 305, the safety controller 13 executes step 307 next.

In step 306, the safety controller 13 calculates the detection end position by adding the value of the half (½) of the vertical direction length of the object 10 to be detected to the data which is the closest to the current position data 201 of the floor position data 203 on the respective floors. Since the movement direction of the car is the downward direction, the detection end position data indicates the position of the car 1 when the position detection sensor 9 detects the upper end of the object 10 to be detected. After execution of step 306, the safety controller 13 executes step 307 next.

In step 307, the safety controller 13 calculates a position data correction amount by calculating a difference between a value of the detection end position data calculated in step 305 or step 306 and a value of the past position data 202 which is previous by the amount of the radio communication delay time. Incidentally, in the present embodiment, when the past position data 202 is larger than the detection end position data, the position data correction amount has a negative value, and when the past position data 202 is smaller than the detection end position data, the position data correction amount has a positive value. After execution of step 307, the safety controller 13 executes step 308 next.

In step 308, the safety controller 13 decides whether an absolute value of the position data correction amount calculated in step 307 is within a predetermined value. When the correction amount is within the predetermined value (YES in step 308), the safety controller 13 executes step 309 next, and when the correction amount is not within the predetermined value (NO in step 308), that is, when the correction amount is larger than the predetermined value, the safety controller 13 executes step 310 next.

In step 309, the safety controller 13 adds the position data correction amount calculated in step 307 to the current position data 201. Thereby, the current position data 201 is corrected. Incidentally, when the position data correction amount is negative, the current position data 201 is corrected to a value smaller than a value before correction, and when the position data correction amount is positive, the current position data 201 is corrected to a value larger than a value before correction. After execution of step 309, the safety controller 13 ends the series of processes.

In step 310, the safety controller 13 decides that the elevator system is abnormal from results of decisions in steps 303, 308 and transmits the stop command to the controller 12. When the controller 12 receives the stop command, the controller 12 halts normal ascending and descending operations of the car 1. That is, the controller 12 switches the operation mode to the emergency control operation. In the emergency control operation, for example, the car 1 moves to the nearest floor and stops. Incidentally, the step 310 is reached when the radio communication delay time is extremely long and when the position data correction amount is extremely large. In these cases, it is presumed that something abnormal is occurring in the elevator system, and therefore the operation mode of the elevator is switched from a normal operation to the emergency control operation. After execution of the step 310, the safety controller 13 ends the series of processes.

According to the above-described embodiment, the safety controller 13 has with the storage device which stores the past position data 202 of the car calculated in advance of the time point at which the detection signal which indicates that it detected object 10 to be detected is received from the position detection sensor 9, and corrects the position of the car in accordance with the correction amount calculated on the basis of the radio-communication-induced communication delay time and the past position data 202. Thereby, even if a communication delay occurs, when the position of the car is corrected in accordance with the position of the object to be detected in a detection of the object 10 to be detected by the position detection sensor 9 which is installed on the car, deterioration in correction accuracy can be suppressed. Accordingly, the car position detection accuracy can be improved without increasing the number of sensors.

In addition, since the correction amount is calculated in accordance with the difference between the past position data 202 which is previous by the amount of the communication delay time and the position of the object 10 to be detected, the deterioration in correction accuracy can be suppressed by comparatively simple processing.

In addition, since the position of the car can be corrected at an early stage before floor-landing by setting the position of the object 10 to be detected which is used for correction amount calculation to the position of the upper end part or the lower end part of the object 10 to be detected, floor-landing accuracy is surely improved.

In addition, the storage device stores the plurality of floor position data which indicate the positions of the plurality of floors on which the objects to be detected are installed, this floor position data is set as the position data on the object to be detected at ½ of the vertical direction length of the object to be detected, the position of the upper end part thereof is calculated by adding ½ of the length of the detection plate to the floor position data, and the position of the lower end part thereof is calculated by subtracting ½ of the length of the detection plate from the floor position data. Thereby, the correction accuracy is improved regardless of the movement direction of the car.

In addition, in the plurality of floor position data, the positions of the upper end part and the lower end part are calculated by using the floor position data which is the closest to the position of the car calculated on the basis of the pulse signal of the encoder at the time point that the detection signal from the position detection sensor 9 is received, and thereby the position of the object 10 to be detected or the floor position for obtaining the correction amount can be set comparatively with ease even when the object 10 to be detected does not have detailed floor position information. Accordingly, the configuration and the shape of the object 10 to be detected can be simplified.

Incidentally, the present invention is not limited to the aforementioned embodiment, and various modified examples are included. For example, the aforementioned embodiment is described in detail in order to describe the present invention comprehensively, and it is not necessarily limited to the one which has all the configurations which have been described. In addition, it is possible to add/delete/replace another configuration to/from/with part of one configuration of each embodiment.

For example, data transmission may be performed between the position detection sensor 9 and the safety controller via wired communication. Also, in a case of the wired communication, when the communication delay time generated due to a communication system, a communication line length etc. affect the correction accuracy, the deterioration in correction accuracy can be suppressed similarly by the correction processing in the above embodiment (FIG. 3).

In addition, the encoder 8 may be installed on the traction machine 4.

In addition, a half of time between when the control-panel-side terminal device 15 or the safety controller 13 transmits a flag signal to the car-side terminal device 14 and when the car-side terminal device 14 sends it back thereto may be set as the communication delay time.

In addition, the position detection sensor 9 may be a photoelectric sensor and may be a magnetic sensor. The object 10 to be detected may be a light shielding plate and may be a magnetic shielding plate.

In addition, a radio repeater may be installed between the car-side terminal device 14 and the control-panel-side terminal device 15.

In addition, the elevator may have a machine room that the traction machine and the control panel are installed and may be a so-called machine-room-less elevator.

### REFERENCE SIGNS LIST

1 . . . car, 2 . . . counter weight, 3 . . . main rope, 4 . . . traction machine, 5 . . . brake, 6 . . . governor rope, 7 . . . governor, 8 . . . encoder, 9 . . . position detection sensor, 10 . . . object to be detected, 11 . . . elevator control panel, 12 . . . controller, 13 . . . safety controller, 14 . . . car-side terminal device, 15 . . . control-panel-side terminal device

1. An elevator control apparatus which, upon receiving a detection signal that a position detection sensor which is installed on a car outputs when the position detection sensor detects an object to be detected which is installed in a hoistway, corrects a position of the car calculated on the basis of a pulse signal that an encoder which rotates in accordance with ascending and descending of the car outputs, in accordance with a position of the object to be detected, comprising a storage device which stores data on the position of the car calculated prior to a time point when the detection signal is received from the position detection sensor,
wherein a correction amount of the position of the car is calculated on the basis of a communication delay time and the data which is stored in the storage device, and
the position of the car is calculated in accordance with the correction amount.

2. The elevator control apparatus according to claim 1,
wherein the correction amount is calculated in accordance with a difference between the data which depends on the communication delay time and the position of the object to be detected.

3. The elevator control apparatus according to claim 2,
wherein the position of the object to be detected is a position of an upper end part or a lower end part of the object to be detected.

4. The elevator control apparatus according to claim 3,
wherein the position of the object to be detected is the lower end part when a movement direction of the car is an upward direction and is the upper end part when the movement position of the car is a downward direction.

5. The elevator control apparatus according to claim 3,
wherein the storage device stores a plurality of floor position data which indicate positions of a plurality of floors on which the objects to be detected are installed,
the floor position data is position data of the object to be detected at ½ of a vertical direction length of the object to be detected,
the position of the upper end part is calculated by adding ½ of the length of the object to be detected to the floor position data, and
the position of the lower end part is calculated by subtracting ½ of the length of the object to be detected from the floor position data.

6. The elevator control apparatus according to claim 5,
wherein the position of the upper end part and the position of the lower end part are calculated by using the floor position data which is the closest to the position of the car calculated on the basis of the pulse signal of the encoder, of the plurality of of floor position data.

7. The elevator control apparatus according to claim 1,
wherein a command signal for an emergency control operation of the elevator is output when the communication delay time is larger than a predetermined value.

8. The elevator control apparatus according to claim 1,
wherein a command signal which commands an emergency control operation of the elevator is output when the correction amount is larger than a predetermined value.

9. The elevator control apparatus according to claim 1,
wherein the detection signal that the position detection sensor outputs is received via radio communication.

10. The elevator control apparatus according to claim 1,
wherein the encoder is installed on a governor.
